(19) United States
(12) Patent Application Publication
(10) Pub. No.: US 2010/0044931 A1
(43) Pub. Date: Feb. 25, 2010

(54) METALLURGICAL VESSEL, IN PARTICULAR ARC FURNACE

(76) Inventors: Norbert Uebber, Langenfeld (DE); Guido Kleinschmidt, Moers (DE); Jochen Schlueter, Meerbusch (DE); Udo Falkenreck, Bochum (DE)

Correspondence Address: K.F. ROSS P.C., 5683 RIVERDALE AVENUE, SUITE 203 BOX 900, BRONX, NY, 10471-0900, US

(21) Appl. No.: 12/514,850

(22) PCT Filed: Oct. 22, 2007
(86) PCT No.: PCT/EP07/09139

§ 371 Date: May 14, 2009

(30) Foreign Application Priority Data
Nov. 17, 2006 (DE) 10 2006 054 344.0

(51) Int. Cl. F27B 3/22; C22B 9/21; F27B 3/24; F27B 3/28; F27B 3/20; F27B 3/16

(52) U.S. Cl. 266/99; 266/216

(57) ABSTRACT

The invention relates to a metallurgical vessel (1), in particular an arc furnace, having a holding container (2) for metal melt and having a lid (3), by means of which the holding container (2) can be at least partially covered, wherein the metallurgical vessel also has at least one lance (4, 5) for the supply of a medium into the metallurgical vessel (1), and wherein the at least one lance (4, 5) is pivotably arranged on or in the metallurgical vessel (1). In order to be able to introduce a medium into the interior of the furnace in an improved manner, the invention provides that at least one lance (4, 5) is arranged in the region of the lid (3) of the metallurgical vessel (1) on a revolute joint (6) which has a rotational axis aligned in a horizontal direction (H).

The invention relates to a metallurgical vessel, in particular an arc furnace, with a vessel for molten metal and a cover that can at least partially cover the vessel, the metallurgical vessel furthermore having at least one lance for feeding a medium into the metallurgical vessel and the lance being pivotally mounted on or in the metallurgical vessel.

To support and accelerate melting processes, for foaming slag and for burning off byproducts, it is known with metallurgical vessels of this type to use lances with which a medium can be fed into the reaction area of the furnace. It is usually oxygen that is supplied in this manner.

Various techniques are used for injecting in particular oxygen into the arc furnace process for the purpose of supporting and accelerating the melting process, the provision of carbon monoxide for foamed slag formation and burning off, for example, carbon and phosphorous, from the melt. Door lances that can be water-cooled or sacrificial, fixed wall injectors, side lances and top lances should be mentioned.

A generic metallurgical vessel is known from EP 0,048,007 [U.S. Pat. No. 4,392,637]. The furnace described there for melting metal has in one of its side walls a hole through which an oxygen nozzle projects into the interior of the furnace. The nozzle is supported on a pivot having has elements in the form of a balls with which it is possible to adjust the angle of the nozzle in order to optimize process conditions.

A solution of this type is also disclosed in DE 1,508,154 [U.S. Pat. No. 3,549,1391, according to which a lance guide pivotal in a vertical plane is provided for an axially displaceable lance, the pivot with the lance guide remaining outside the furnace area. The pivot permits swinging of the lance about a horizontal axis that lies outside the furnace.

Similar solutions are shown in EP 0,725,150 [5,788,920], in DE 4,034,809, in DE 196 37 246, in US 2003/0075843 and in U.S. Pat. No. 4,653,730. The lances for injecting in particular oxygen are always supported outside the furnace and project into the interior of the furnace through a side wall. Further solutions comparable thereto are disclosed by DE 195 47 885, GB 887,168, FR 2,489,841, EP 0,418,656 [U.S. Pat. No. 5,332,199] and DE 27 38 291.

With the solutions previously known there are always disadvantages, depending on the construction type. In the case of door lances, the process cannot be operated with the furnace closed, which results in energy and metallurgical disadvantages.

With the use of top lances, a separate pivot drive is necessary. Furthermore, in this case the arc and the top lance cannot be operated simultaneously.

In the case of wall-mounted, water-cooled lances, a wall bushing is necessary. Furthermore, there is a substantial space requirement outside the furnace. Moreover, with fixed wall injectors, there is no adaptability to different melt levels in the furnace. This is a disadvantage in particular with the continuous conveyance and use of large DRI quantities. If the distance between the nozzle opening and the melt is too small, there is a danger of the nozzle clogging and of refractory wear due to excessively low gas penetration into the molten bath. If the distance between the nozzle opening and the melt is too large, the discharge of oxygen is too low.

The object of the invention is therefore to avoid the above disadvantages and to provide a metallurgical vessel, in particular an arc furnace, in which a medium, in particular oxygen or a burner gas for generating foamed slag, for burning off byproducts or for supporting the melting process can be injected into the furnace during operation of the arc furnace when the vessel is closed, it being possible to adjust the discharge opening of the lance to the height of the melt or scrap level in a simple manner.

This object is attained by the invention in that the at least one lance is arranged on the cover of the metallurgical vessel on a pivot that has a horizontal rotation axis.

The pivot is thereby preferably attached to an inside face of the cover. Furthermore, the lance can be water-cooled.

The lance can furthermore be shaped like a fork and have two or even more outlets. In this case two fork-shaped lances are present that are supported on opposite points of the cover in respective pivots. The fork-shaped lance is thereby advantageously arranged such that it outlets lie on both sides of electrodes arranged centrally in the cover.

An improved distribution of the injected medium can be achieved if at least one of the outlets of the lance has several nozzles.

Furthermore, an actuator can be present that position the at least one lance in predetermined angular positions. It is particularly advantageous thereby—as will be explained in further detail—if the actuator have a no-load mode of operation, in which the lance through its own weight rests on the material to be melted down in the furnace interior.

Finally, a further development provides that a sensor is provided that can determine the angular position of the lance, in particular with respect to the horizontal.

With the proposed embodiment it is possible to ensure an efficient usage of oxygen and other media adapted to the melt state and bath level in the vessel when the furnace vessel is closed.

To this end, for example, the preferably water-cooled lance is positioned vertically via a pivot under the cover of the arc furnace such that the position of the nozzle outlet of the lance can be adjusted when the vessel is covered and with different melt levels in the furnace, and thus an optimal oxygen input into the melt is ensured. Furthermore, in the melting phase of the scrap the position of the nozzle outlet can also be adjusted to the scrap height for optimal support of the melting process.

For more efficient oxygen usage during melting of the scrap, for foamed slack formation or for decarburizing, it is advantageous to use several locally distributed oxygen feeds as proposed above according to the further development. To this end a plurality of such lances can be used.

In addition to a nozzle outlet for metallurgically used oxygen on the lance, there is also the possibility, instead of the oxygen acting essentially metallurgically or in addition to this, of feeding burner gases with the oxygen necessary for this for the purpose of supporting the melting process with the lance and thus of operating burner flames in a manner adapted to the scrap height and thus more economically.

In order to increase the effectiveness of the oxygen input and to cover a larger area of the melt, the lance heads can be equipped with several nozzles so that several oxygen outlets arranged in an array are available for the melt.

In order to obtain an indication of the scrap height during the melt-down process, the procedure can be such that at the start of the melting process the lance or the lances are lowered until they rest on the scrap, so that they then sink down with their one end acted on by the force of gravity to rest further on the scrap. The detected angular position at the pivot is then a gauge of the scrap level.

The invention permits oxygen feed to be adjusted to the melt conditions in a closed arc vessel. This leads to a high energy and metallurgical efficiency of the process. In an analogous manner, burner flames at the nozzle outlet of the lances can be used for melting the scrap.

Embodiments of the invention are shown in the drawing. Therein:

FIG. 1 is a diagrammatic side view of an arc furnace with partial representation of the inner elements of the furnace,

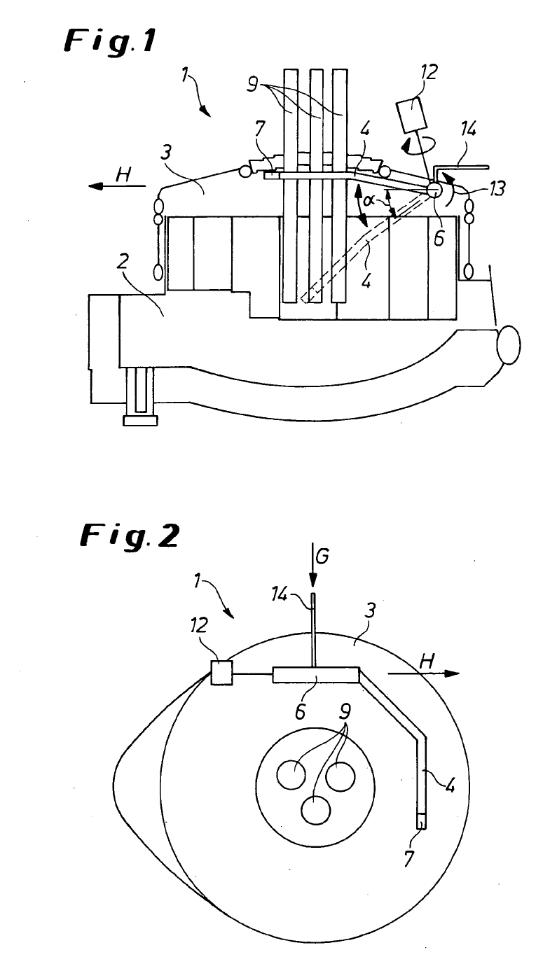

FIG. 2 is a diagrammatic plan view of the furnace according to FIG. 1,

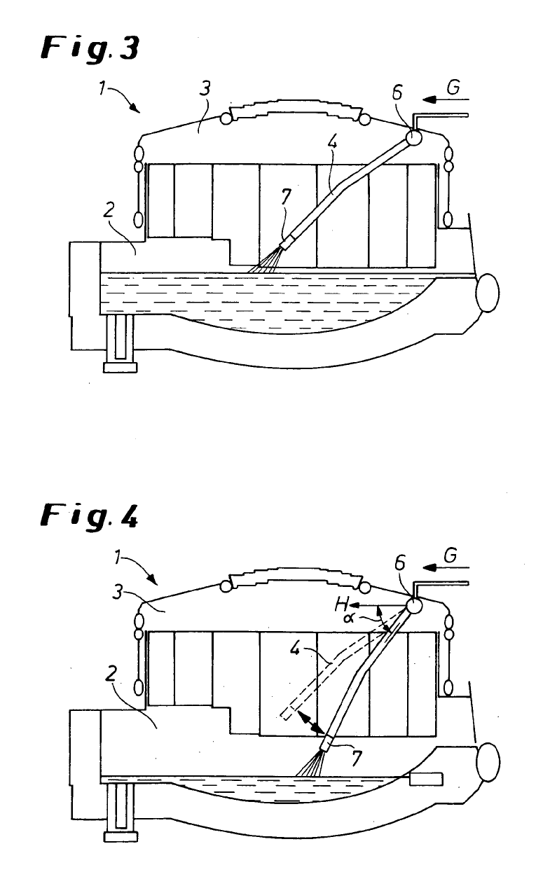

FIG. 3 is a view like FIG. 1 with the furnace filled with melt to a first level,

FIG. 4 is a view like FIG. 3 with the furnace filled with melt to a second level,

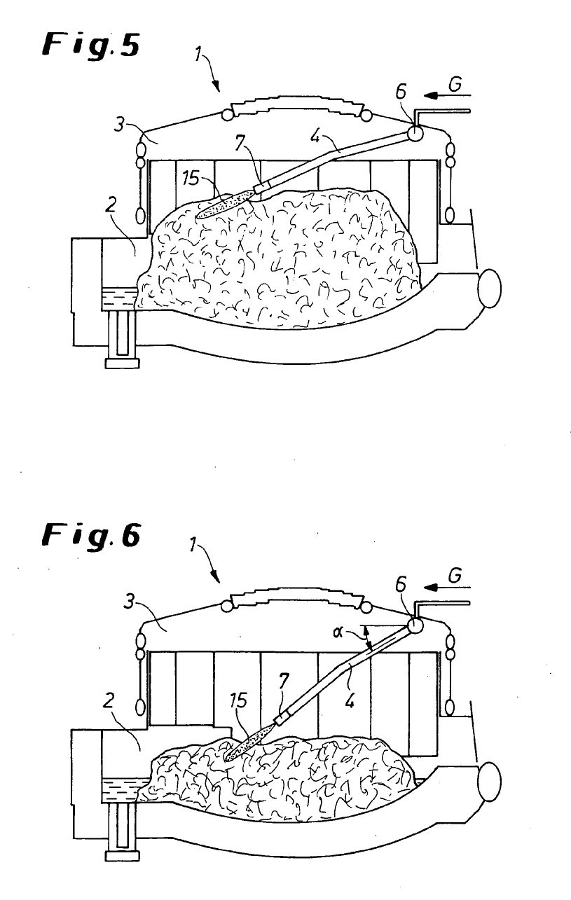

FIG. 5 is a view like FIG. 1 with the furnace filled with scrap to the first level,

FIG. 6 is a view like FIG. 5 with the furnace filled with scrap to the second fill level,

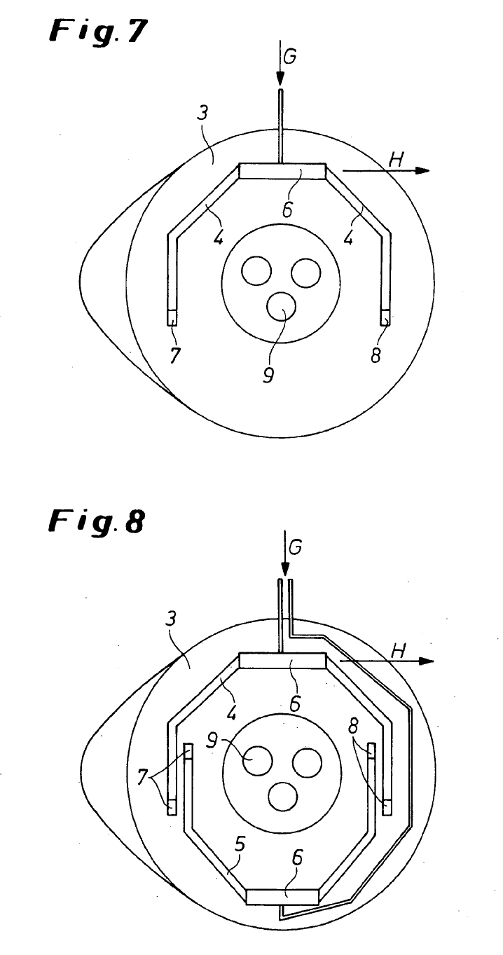

FIG. 7 is a diagrammatic plan view of the furnace according to FIG. 1 according to a first alternative embodiment of the invention,

FIG. 8 is a diagrammatic plan view of the furnace according to FIG. 1 according to a second alternative embodiment of the invention, and

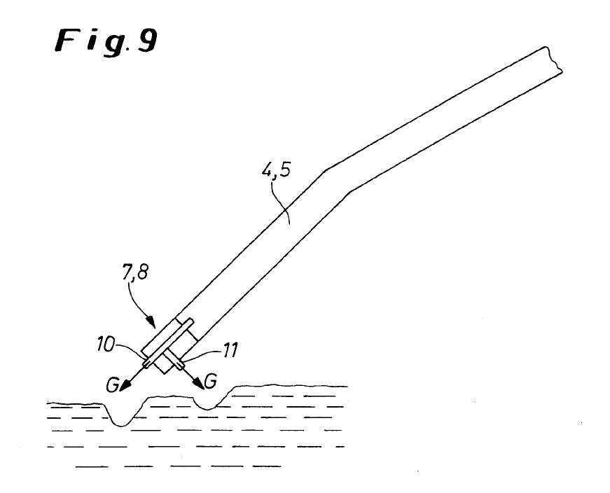

FIG. 9 shows the end of a lance with several nozzles.

FIGS. 1 and 2 show a metallurgical vessel 1, here an electric arc furnace having a vessel 2 that can be closed by a cover 3. The cover 3 is mounted on the vessel 2 by a hinge, as is known per se.

In order to be able to supply for example burner gas during the melting of scrap or to be able to add oxygen to the melt during steel production, a lance 4 is provided that is water-cooled and has an outlet 7 on its side facing toward the melt.

The lance 4 is thereby supported in a pivot 6 that is attached to the inside of the cover. The axis of the pivot 6 extends in the horizontal direction H. Furthermore, an actuator 12 are provided, with which the lance 4—measured for example with respect to the horizontal H—can be pivoted by an angle α. The angle position of the lance 4 actually present after the pivoting action is determined with a sensor 13 which is shown indicated only diagrammatically in FIG. 1, but which is sufficiently known per se.

In the present case three electrodes 9 are arranged centrally in the cover 3, via which electrodes the arc is generated. As can be seen in FIG. 2, the lance is arcuate so that it can be pivoted without colliding with the electrodes 9.

In the case of the supply of a medium G (e.g. oxygen) via a supply line 14 into the lance 4, the medium emerges at the outlet 7.

When FIGS. 3 and 4 are taken together, it can be seen how the lance 4 can be pivoted. In FIG. 3 a higher bath level of the molten metal in the vessel 2 is present than is the case in FIG. 4. The actuator 12 (see FIGS. 1 and 2) is operated by an unillustrated controller to position the lance 4 such its outlet 7 is always at an optimal spacing from the surface of the melt.

It is also possible to operate if no melt is in the vessel 2, but instead scrap to be melted down. This is shown in FIGS. 5 and 6. First the lance 4 with its outlet 7 is held at a higher level, as can be seen from FIG. 5. As the scrap melts, the surface of the scrap sinks so that the lance pivots downward with it. In this case the actuator 12 is inactive so that the lance 4 rests on the scrap solely by its own weight. The lance thus sinks down as the scrap melts down. The burner flame 15 created by the burner gas is indicated in FIGS. 5 and 6.

Whereas with the embodiment according to FIGS. 3 and 4 to produce the steel, oxygen is supplied via the lance 4, according to FIGS. 5 and 6 the melting process is supported by the addition of burner gas.

The effectiveness of the media addition can be intensified with the measures shown in FIGS. 7 and 8.

In FIG. 7 the lance 4 is fork-shaped manner; it therefore has two relatively spaced outlets 7 and 8. These are arranged such that they lie on both sides of the electrodes 9 or can be pivoted up and down on both sides of the electrodes 9.

In the case of the solution shown in FIG. 8, it is provided that two fork-shaped lances 4 and 5 are arranged in the cover 3. Medium G can thus be injected from a total of four outlets 7 and 8. The spacing of the forks is chosen such that no collisions take place here either.

In order to make injection of the medium G even more effective and to better distribute the medium, according to FIG. 9 the outlet 7 and 8 of the lances 4 and 5 has several—in this case two—nozzles 10 and 11.

### List of Reference Numbers

1 Metallurgical vessel
2 Vessel
3 Cover
4 Lance
5 Lance
6 Pivot
7 Outlet
8 Outlet
9 Electrode
10 Nozzle
11 Nozzle
12 Actuator
13 sensor
14 Feed line
15 Burner flame
H Horizontal direction
α Angular position/pivot angle
G Medium (gas, oxygen, burner gas)

1. A metallurgical vessel, in particular an arc furnace, with a vessel for molten metal and a cover that can at least partially upwardly close the vessel, the metallurgical vessel furthermore having at least one lance for feeding a medium into the metallurgical vessel, the lance being pivotally mounted on or in the metallurgical vessel wherein the lance is mounted on the cover of the metallurgical vessel on a pivot that has a rotational axis extending in a horizontal direction.

2. The metallurgical vessel according to claim 1 wherein the pivot is attached to an inside face of the cover.

3. The metallurgical vessel according to claim 1 wherein the lance is water-cooled.

4. The metallurgical vessel according to claim 1 wherein lance is fork-shaped and has two outlets.

5. The metallurgical vessel according to claim 4 wherein two fork-shaped lances are present that are supported on opposite points of the cover in respective pivots.

6. The metallurgical vessel according to claim 4 wherein the fork-shaped lance is arranged such that the outlets lie on both sides of electrodes arranged centrally in the cover.

7. The metallurgical vessel according to claim 1 wherein at least one of the outlets of the lance has several nozzles.

8. The metallurgical vessel according to claim 1 wherein an actuator is provided that can position the lance in a predetermined angular position.

9. The metallurgical vessel according to claim 8 wherein the actuator has a no-load mode of operation in which the lance rests only with its own weight on the material to be melted inside the furnace.

10. The metallurgical vessel according to claim 1 wherein a sensor is provided for determining the angular position of the lance with respect to the horizontal.

11. In an arc furnace having
an upwardly open vessel adapted to hold a material to be melted,
a cover fittable over the vessel, and
an elongated lance having an outlet end for introducing a process gas into the vessel for heating the material therein, the improvement comprising
a pivot on a lower face of the cover carrying the lance for pivoting of the lance underneath the cover about a horizontal axis for vertical positioning of the outlet end.

12. The improvement defined in claim 11, further comprising
means for cooling the lance with water.

13. The improvement defined in claim 11 wherein the lance is fork-shaped and has two outlets.

14. The improvement defined in claim 13 wherein there are two such fork-shaped lances having respective such pivots spaced apart on the cover.

15. The improvement defined in claim 13 wherein the furnace has an electrode, the fork-shaped lance having two arms flanking the electrode.

16. The improvement defined in claim 11 wherein the outlet end is provided with a plurality of nozzles.

17. The improvement defined in claim 11, further comprising
an actuator for pivoting the lance about the pivot axis and angularly holding the lance in any of a plurality of angularly offset positions.

18. The improvement defined in claim 16 wherein the actuator has a no-load move, whereby in the no-load mode the lance can swing freely about the axis.

19. The improvement defined in claim 11, further comprising
a sensor for detecting an angular position of the lance.
